(19) United States
(12) Patent Application Publication
(10) Pub. No.: US 2016/0342801 A1
(43) Pub. Date: Nov. 24, 2016

(54) CONTAINERIZED SECURITY AS A SERVICE

(71) Applicant: defend7, Inc., Mountain View, CA (US)

(72) Inventors: Vibhav Sreekanti, Pleasanton, CA (US); Gaurav Mathur, Palo Alto, CA (US)

(21) Appl. No.: 14/519,954

(22) Filed: Oct. 21, 2014

Related U.S. Application Data
(60) Provisional application No. 62/016,703, filed on Jun. 25, 2014.

(51) Int. Cl. G06F 21/62; G06F 21/60

(52) U.S. Cl. CPC G06F 21/6218; G06F 21/602

(57) ABSTRACT

Systems, methods, and software described herein provide security preferences to application containers executing independently on a host computing system. In one example, a method of operating a management service to manage security preferences for containerized applications includes receiving an initiation request from a security module in an application container. The method further provides, responsive to the request, identifying configuration parameters for the application container, the configuration parameters corresponding to unique security preferences based on one or more applications in the application container, and transferring the configuration parameters to the application container.

### RELATED APPLICATIONS

This application is related to and claims priority to U.S. Provisional Patent Application No. 62/016,703, entitled “CONTAINERIZED SECURITY AS A SERVICE,” filed on Jun. 25, 2014, and which is hereby incorporated by reference in its entirety.

### TECHNICAL FIELD

Aspects of the disclosure are related to computing security and in particular to providing a secure container for applications.

### TECHNICAL BACKGROUND

An increasing number of data security threats exist in the modern computerized society. These threats may include viruses or other malware that attacks the local computer of the end user, or sophisticated cyber attacks to gather data and other information from the cloud or server based infrastructure. This server based infrastructure includes real and virtual computing devices that are used to provide a variety of services to user computing systems, such as data storage, cloud processing, web sites and services, amongst other possible services. To protect applications and services, various antivirus, encryption, and firewall implementations may be used across an array of operating systems, such as Linux and Microsoft Windows.

A firewall is a software or hardware-based network security system that controls the incoming and outgoing network traffic based on applied rule set. For example, a firewall may be implemented in a computing system to prevent incoming connections from possibly harmful computing systems. Further, encryption is the process of encoding messages or information in such a way that only authorized parties may read or understand the saved material. Thus, if users attempt to store sensitive information, such as social security information, encryption may be used as a failsafe to prevent unwanted parties from reading the information even if the stored data is accessible.

In addition to the protective measures discussed above, segregation methods have also been pursued to limit the interaction between systems and applications. These segregation methods include whole system virtualization, which includes a full operating system and one or more applications, as well as application containers that are used to reduce dependencies on other cooperating applications. However, separating the applications into different virtual machines or application containers can add complexity to the security configurations for each of the executing applications.

### OVERVIEW

Provided herein are systems, methods, and software to provide security preferences to application containers executing independently on a host computing system. In one example, a method of operating a management service to manage security preferences for containerized applications includes receiving an initiation request from a security module in an application container. The method further provides, responsive to the request, identifying configuration parameters for the application container, the configuration parameters corresponding to unique security preferences based on one or more applications in the application container, and transferring the configuration parameters to the application container.

In another instance, a computer apparatus to manage security preferences for containerized applications includes, processing instructions that direct a management service computing system to receive an initiation request from a security module in an application container. The processing instructions further direct the management service to, in response to the request, identify configuration parameters for the application container, the configuration parameters corresponding to unique security preferences based on one or more applications in the application container. The processing instructions also direct the management service to transfer the configuration parameters to the application container. The computer apparatus further includes one or more non-transitory computer readable media that store the processing instructions.

In a further example, a computer apparatus to provide security to an application with an application container includes processing instructions that direct a host computing system to identify a security configuration request initiated by a security layer within the application container. The processing instructions further direct the host computing system to, responsive to the security configuration request, transfer a request to a management service for security configuration parameters corresponding to the application container, and receive the security configuration parameters for the application container. The computer apparatus also includes one or more non-transitory computer readable media that store the processing instructions.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a computing environment to separate applications into specialized containers.

FIG. 2 illustrates an operational scenario to initiate an application container within a computing environment.

FIG. 3 illustrates a method of operating a management service to manage security preferences for containerized applications.

FIG. 4 illustrates an application container for managing securitization of an application.

FIG. 5 illustrates an overview of implementing security preferences within an application container.

FIG. 6 illustrates an overview of implementing security preferences within an application container.

FIG. 7 illustrates an overview of implementing security preferences for multiple application containers.

FIG. 8 illustrates an overview of implementing security preferences for multiple application containers.

FIG. 9 illustrates a system to provide application containers with individualized security preferences.

FIG. 10 illustrates a management service computing system to provide security preferences to application containers.

FIG. 11 illustrates a host computing system to provide secure application containers.

### TECHNICAL DISCLOSURE

Internet services rely extensively on security to prevent unpermitted processes and users from accessing sensitive data. Such data may include usernames, passwords, social security numbers, credit card numbers, amongst other sensitive data. To prevent the unpermitted access, firewalls, antiviruses, and other security processes may be executed on the devices hosting the internet services. These security processes are designed to prevent improper access, or mitigate the effects once a breach has occurred.

In some examples, multiple applications may be necessary to provide specific services to end user devices, such as front-end applications, back-end applications, and other data service applications. Each of these applications is responsible for a particular task, such as taking in and storing the data, processing the data that is received, organizing the data received, or any other task necessary for the service. These applications may be implemented on one or more computing devices configured by an administrator to perform the associated service.

In the present example, application containers are included to segregate the applications and help secure the data as it is used within the service. These application containers, which operate on a host computing system, can package an application and its dependencies in a virtual container that can execute on a variety of operating systems and versions thereof. These containers may include various versions of Linux containers, jails, partitions, or virtual machines, amongst other types of containment modules. Accordingly, because the application does not contain any dependencies from other applications or processes on the host, the application is essentially segregated from other applications and processes executing on the same host computing system. Here, in addition to the application, the container also includes a security layer to act as a barrier or intermediary between applications, processes, and data storage external to the application container. This security layer may include encryption, firewall, storage interface, and communication interface modules that can be configured based on the application for the container. For example, a front-end application that places data within a storage volume may not require access to sensitive data values, such as social security numbers and credit card numbers. Accordingly, rather than letting the application read the received sensitive data, the security layer may encrypt the received data before passing the data to the application.

To configure the security layer, a management module within the application container may be included to gather the appropriate preferences for the application. This management module may transfer a query to an external management service, which verifies the container, and identifies security parameters based on preferences established for the one or more applications within the container. Once the security parameters are identified, the external management service may transfer the parameters back to the application container to be implemented.

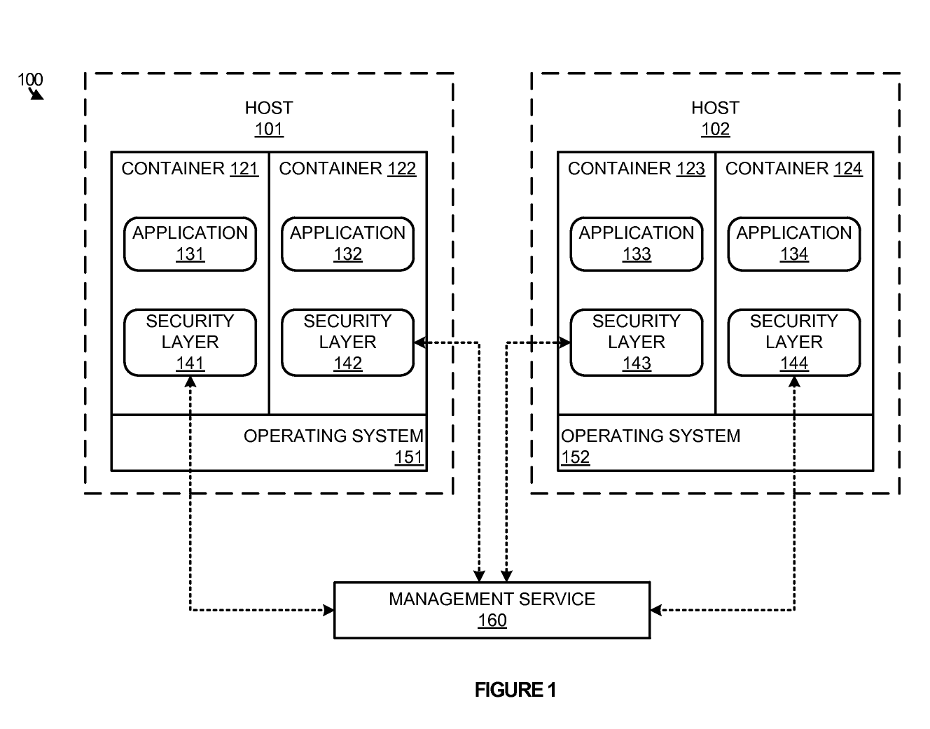

Referring now to FIG. 1, FIG. 1 illustrates a computing environment 100 to separate applications into specialized containers. Computing environment 100 includes hosts 101-102 and management service 160. Hosts 101-102 further include operating systems 151-152, which may comprise Linux distributions in some examples, and are capable of operating applications 131-134. Hosts 101-102 further include containers 121-124, which are used to segregate applications 131-134 and security layers 141-144. Instead of allowing the application to coexist with other applications on the host computing systems, containers 121-124 isolate applications and their components from the other applications and components on the hosts. Thus, application 131 does not recognize or have access to application 132, although both applications are located on the same machine.

In addition to the applications, containers 121-124 include security layers 141-144 that are used to implement security parameters based on preferences for the applications located within the same container. These preferences may include firewall preferences, communication interface preferences, storage interface preferences, and encryption preferences, amongst a variety of other security preferences. In some examples, security layers 141-144 use utilities that are provided by the operating systems themselves. For instance, operating system 151 may include a firewall that can be configured to protect applications and data. Accordingly, security layer 141 may use the firewall to create a specific security setting for application 131. At the same time, security layer 142 may use the firewall included within operating system 151 to create a specific security preference for application 132. Thus, although applications 131-132 may operate independently of one another, the tools presented by the operating system may be used to create unique security settings for each of the containers.

To accommodate the individualized security settings or parameters for the containers, management service 160 is included. Management service 160 may include a centralized service for all companies, websites, and other services using the secure containerized applications, or may be service specific that is individualized for each deployment of the containerized applications. In operation, when the containers are initialized with the corresponding applications, management service 160 provides the security configuration parameters necessary for the individual applications. As a result, unmodified service applications may be instantiated in a container with a security layer that is configured by the management service. This wrapping of the application allows the applications to be unmodified, but provides security using the secure wrapper for the application.

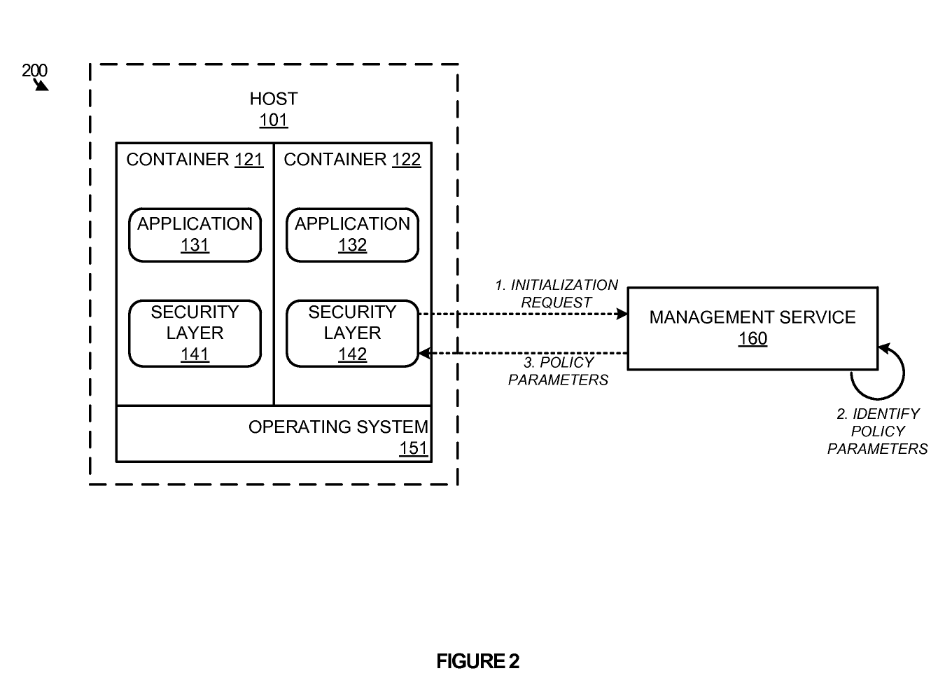

To further illustrate the operation of computing environment 100, FIG. 2 is included. FIG. 2 illustrates an operational scenario 200 to initiate a container within computing environment 100. As depicted, when container 122 is initialized, security layer 142 is used to initialize a configuration or initiation request to management service 160. Responsive to the request, management service 160 verifies the container, and identifies policy parameters based on preferences for the applications, and provides the policy parameters to security layer 142. Once the policy parameters are delivered, security layer 142 implements the parameters and makes application 132 available to the service.

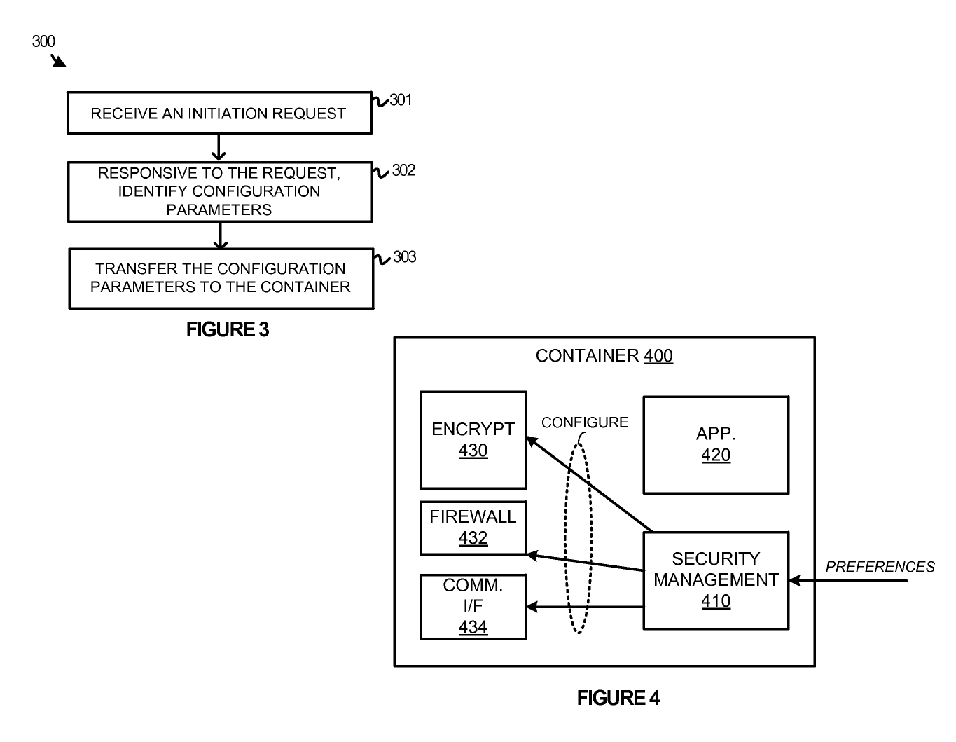

For a further illustration of operating the management service, FIG. 3 is provided. FIG. 3 illustrates a method 300 of operating a management service to manage security preferences for containerized applications. As depicted in method 300, the management service receives an initiation request from a security module in an application container (301). Responsive to the request, the management module identifies configuration parameters for the container that correspond to unique security preferences based on one or more applications in the application container (302). For example, an application that handles sensitive information, such as social security numbers and credit card information, may have different security settings than an application that saves non-sensitive information, such as color preferences and the like. Accordingly, an administrator, a developer, or some other management process may generate unique security preferences for each of the applications based on the type of information that is processed using the application. These preferences may then be translated into configuration parameters for the security layer in the application container.

Once the configuration parameters are determined for the application, the management service transfers the configuration parameters to the particular application container (303). Once received, the security module within the application container may be used to configure the security settings for the application. For instance, the configuration parameters transferred by the management service may include a configuration for the firewall to only receive data or requests from devices with specific Internet Protocol (IP) addresses. Thus, if a communication were transferred to the application, but was not of an acceptable IP address, the communication could be intercepted before reaching the application.

To further illustrate the configuration within the individual application containers, FIG. 4 is provided. FIG. 4 illustrates an application container 400 for managing securitization of an application. Application container 400 includes security management module 410, application 420, encryption module 430, firewall 432, and communication interface 434. Encryption module 430, firewall 432, and communication interface 434 are configurable security modules within container 400, however, it should be understood that other security modules may also be present in container 400.

In operation, security management module 410 initiates an inquiry to a management service to identify security parameters for the particular application, which may occur before the application becomes available. Thus, when a container is instantiated on a host computing system, the security management module within the container may identify the security settings before any data or communications are passed to the application. Once the security preferences are received by security management module 410, security management module 410 configures the other security modules within container 400.

For example, if application 420 comprises a front-end application, firewall 432 may be configured to take in data from one or more end user devices. Further, encryption module 430 may be configured to encrypt any sensitive data that might be received from the end user devices to prevent unauthorized access to the importing information. Accordingly, as data is received, the firewall may prevent unauthorized users from sending or receiving information to application 420, and encryption module 430 may encrypt the data to make the data unreadable before it reaches the application. By wrapping application 420 with security management module 410, encryption module 430, firewall 432, and communication interface 434, application container 400 is capable of providing security to the application without modifying the application itself. Instead, the various security modules may be used to protect the data and the application by managing the incoming and outgoing data communications with the application.

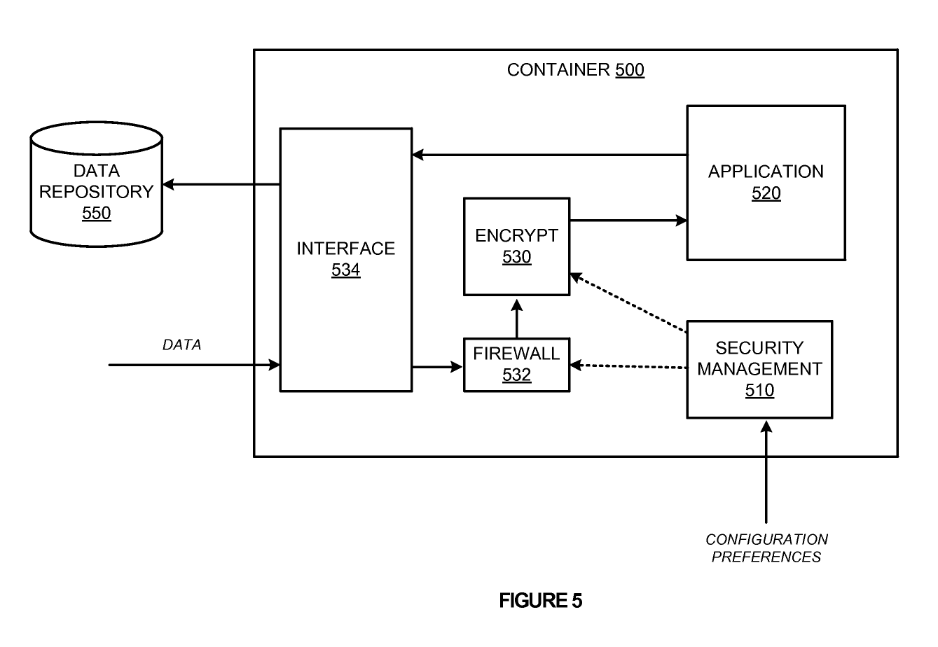

Referring now to FIG. 5, FIG. 5 illustrates an overview of implementing security preferences within an application container. FIG. 5 includes security management module 510, application 520, encryption module 530, firewall 532, interface 534, and data repository 550. In the present example, container 500 is an example of a front-end server capable of receiving sensitive and non-sensitive data.

In operation, one or more end user devices may transfer data to a service to be processed and perform a certain task. These services may include multiple applications, such as front-end applications and back-end applications, which provide different functionality within the service. In the present example, container 500 includes application 520, which is an example of a front-end application. A front-end application may be responsible for collecting input in various forms from end user devices, and processing it to conform to a specification a back-end application can use. To protect the front-end application, security management module 510 is provided that takes in configuration parameters from a management service and implements the parameters using the different security processes. Once the security parameters are implemented, application container 500 may begin receiving data from the end user devices. Here, the data that is received is directed through a firewall and through an encryption module prior to reaching the application. Thus, even if the data that is received by application container 500 as unencrypted, at least a portion of the data that is presented to the application itself will be encrypted. Once the application processes the data, the data is then stored to data repository 550 using interface 534. However, it should be understood that the data processed by application 520 might be passed to another container, or to any other similar destination.

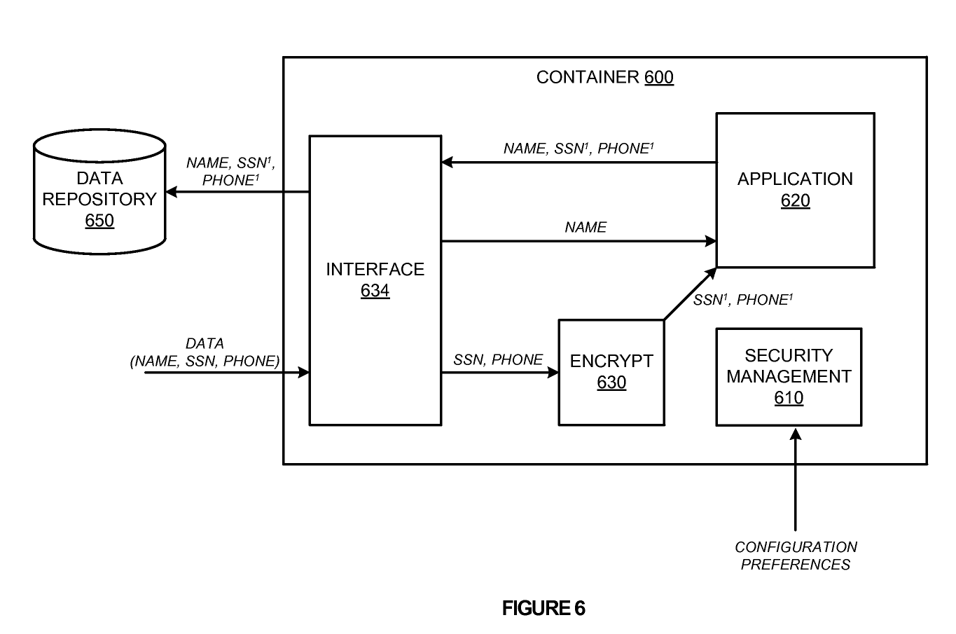

As a further example of applying security management within an application container, FIG. 6 is provided. FIG. 6 is an overview of implementing security preferences within an application container according to one example. FIG. 6 includes security management module 610, application 620, encryption module 630, firewall 632, interface 634, and data repository 650.

In operation, container 600 operates as an isolated userspace instance on top of a host operating system, which allows application 620 and other possible applications within container 600 to operate without identifying other applications or processes operating on the same host. In the present example, container 600 is configured as front-end application to sort incoming communications as they are received from one or more end user devices. Here, the incoming communications include names, social security numbers, and phone numbers, although these data objects are merely illustrative.

As the data arrives, interface 634 is configured by security management module 610 to transfer data to particular modules based on the sensitivity of the data received. Thus, social security numbers and phone numbers are passed to encryption module 630, whereas name data is passed directly to application 620. Once encryption module 630 receives the social security numbers and phone numbers, the data is encrypted before it is passed to application 620. Application 620 then processes the encrypted and non-encrypted data before passing the data back to the interface to be stored in data repository 650. Thus, because application 620 does not require the data received from the end user devices to be unencrypted, security management module 610 may be used to encrypt the data before it is ever received by application 620. Application 620 may then process the data as it is received and transfer the data without potentially exposing the social security numbers and phone numbers to a problem within the application.

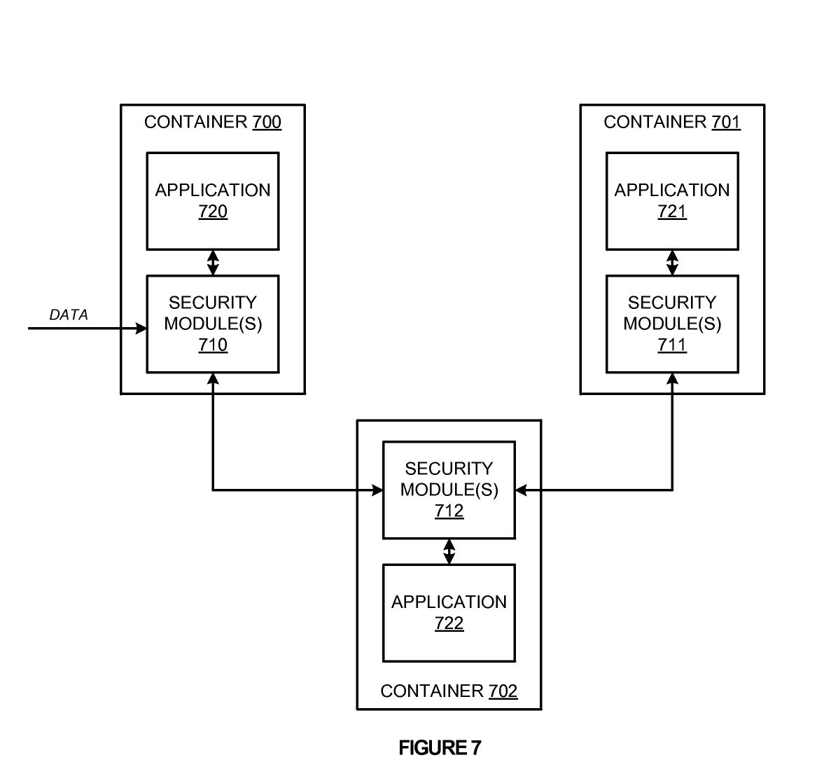

Turning now to FIG. 7 to demonstrate the interaction of multiple containers. FIG. 7 illustrates an overview of implementing security preferences for multiple application containers according to one example. FIG. 7 includes containers 700-702 that further include security modules 710-712 and applications 720-722.

Containers 700-702 operate on one or more host computing devices capable of providing a platform for applications 720-722. Containers 700-702 include all of the components necessary for applications 720-722 to execute without dependencies of other applications or services executing on the host computing devices. In the present example, applications 720-722 are transparently protected within the containers by security modules 710-712. These security modules inquire a management service when the containers are initialized, and are configured by the management service based on the particular application included within the container. For example, a front-end application may require that input data be encrypted before it is actually received by the front-end application, whereas the back-end server may need to decrypt the data prior to being processed by the back-end application.

As depicted, security modules 710-712 may be used as a layer between the various applications of the service. Thus, rather than communicating directly, security modules 710-712 add a layer of security between the end user devices, as well as between the individual applications of the services. Accordingly, each application may have a special security layer to prevent unauthorized access at each level of the service.

Although illustrated in the present example as only communicating with other application containers, it should be understood that each application container might communicate with a variety of computing systems, applications, and storage systems that do not include a security layer. For example, an application may require access to a storage system external to the container. Thus, the security layer may act as a transparent intermediary between the application and the desired storage system.

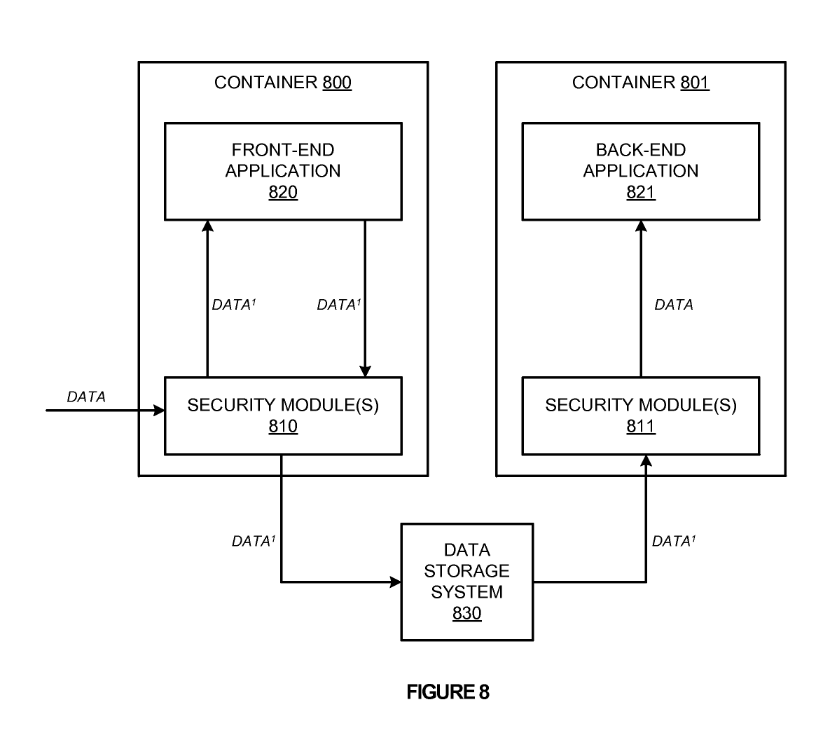

Turning to FIG. 8 as a specific example, FIG. 8 illustrates an overview of implementing security preferences for multiple application containers. FIG. 8 includes application containers 800-801 and data storage system 830. Application containers 800-801 further include applications 820-821 and security modules 810-811. Security modules 810-811 may comprise a security management module, an encryption module, a communication interface module, a storage interface module, or any other similar security related modules to prevent improper access to the data and processes of the application. Data storage system 830 comprises any computing device or system of devices capable of storing data passed from container 800. In some examples, data storage system 830 may comprise a separate application container to handle the actual storage desired by front-end application 820.

In operation, front-end application 820 and back-end application 821 execute within containers 800-801 on one or more host computing systems. For example, container 800 may operate on top of a first host system with a first operating system, and container 801 may operate on a second host system with a second host operating system, although both containers may coexist on the same host system. To initiate the containers, a management module may be included within security modules 810-811 to gather parameters or settings for application security from a management service. Once the parameters are received from the management service, the management module may configure the various security modules based on the parameters received.

For example, referring to FIG. 8, security modules 810 may be configured to encrypt data as it is received from one or more end user devices. As a result, rather than allowing front-end application 820 to receive unencrypted data, the modules may be able to encrypt one or more portions of the data before it is passed to the application. This allows front-end application 820 to process the data without being able to identify the actual values for the data itself. For example, if the data received into container 800 included credit card numbers, security modules 810 may be used to encrypt the credit card numbers, allowing front-end application 820 to place the data into storage system 830 without identifying the credit card number itself.

In contrast to front-end application 820, back-end application 821 makes operations on the data that is stored in data storage system 830. Thus, instead of using an encryption module to encrypt the data that is received by the container, a module may be configured to decrypt any data that needs to be processed by back-end application 821. Consequently, by implementing a security module layer within the containers, the security module layer may be used to limit the number of applications that can view the data without encryption.

In addition to the encryption parameters described above, other security measures may be taken by containers 800-801, such as a firewall to prevent improper communications between the applications and external processes. For example, if back-end application 821 were to only gather data from data storage system 830, then the firewall could be used to prevent any communication from other processes, storage systems, applications, or computing systems. As a result, although applications may be operating on the same real or virtual host, the applications may only receive or send communications with approved services or devices.

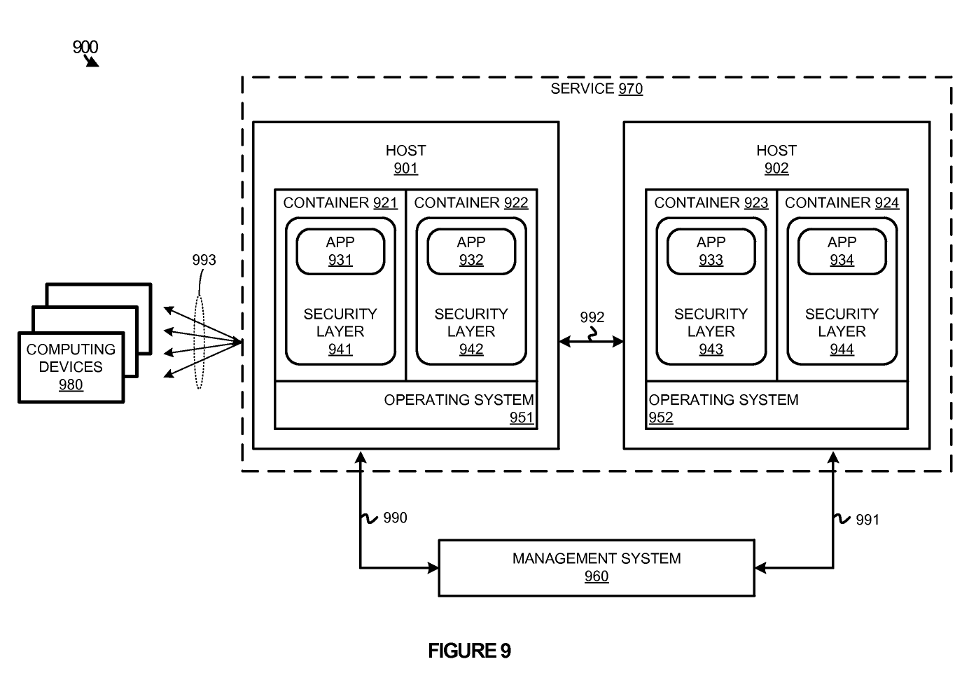

Turning to FIG. 9, FIG. 9 illustrates a system 900 to provide application containers with individualized security preferences. System 900 includes management system 960, service 970, and computing devices 980. Service 970 includes hosts 901-902, which further include operating systems 951-952 and containers 921-924. Containers 921-924 further include security layers 941-944 and applications 931-934. Management system 960 communicates with hosts 901-902 over communication links 990-991. Hosts 901-902 communicate with each other over communication link 992. Computing devices 980 communicate with service 970 and hosts 901-902 over communication link 993. Although illustrated in the present example with a single application, it should be understood that each container might include a plurality of applications within each of the containers.

In operation, containers 921-924 are initiated on hosts 901-902 to provide segregated application environments without the need of individual virtual machines per application. Each container in containers 921-924 includes all of the dependencies necessary for applications 931-934 to execute without borrowing from other applications operating on the host. When the containers are initialized, security layers 941-944 query management system 960 to identify security parameters for the applications. Such parameters may include firewall settings, encryption settings, and communication settings, amongst a variety of other security settings. Once the configuration parameters are received, security layers 941-944 configure one or more security modules based on the settings to prepare the applications for execution.

After the security parameters are implemented for the applications, service 970 may begin processing data using the containerized applications. As illustrated in the present example, computing devices 980 may attempt to communicate with service 970 over communication links 963. However, based on the security settings for each of the applications, the communications may be denied by the security modules. Further, by configuring security for each of the applications, each of the applications may only have readable access to specific portions of the data necessary for that application. For instance, an application that identifies locations for storing credit card numbers may not need access to the actual credit card number. Accordingly, prior to presenting the data to the application, the security layer may encrypt the credit card number, resulting in fewer applications having access to sensitive data.

Referring to the elements of FIG. 9, Hosts 901-902 may each comprise a real or virtual computing device. Hosts 901-902 may include processing systems, storage systems, user interfaces, communication interfaces, or any other similar computing element. In particular, hosts 901-902 include software, hardware, or firmware elements that are capable of maintaining separation between containers 921-924. Containers 921-924 may include Linux container, jails, or any other similar containment module. Further, in some examples, containers 921-924 may comprise virtual machines capable of executing using the resources provided by hosts 901-902.

Management system 960 comprises any real or virtual computing device or group of devices capable of providing security preferences to containers 921-924. Management system 960 may be operated by the service provider, or may be operated as a separate system for a plurality of service providers. Management system 960 may include processing systems, storage systems, user interfaces, communication interfaces, or any other similar computing element. Although illustrated as a separate system in the present example, it should be understood that management system 960 might be implemented wholly or partially on hosts 901-902.

Computing devices 980 may each be a telephone, computer, e-book, mobile internet appliance, media player, game console, or some other computing apparatus—including combinations, improvements, and virtualized variations thereof. Computing devices 980 may each include processing systems, storage systems, user interfaces, communication interfaces, or any other similar computing elements.

Communication links 990-993 use metal, glass, air, space, or some other material as the transport media. Communication links 990-993 could use various communication protocols, such as Time Division Multiplex (TDM), Internet Protocol (IP), Ethernet, communication signaling, a wireless communication format, such as Wireless Fidelity (WIFI), or some other communication format—including combinations thereof. Communication links 990-993 could be direct links or may include intermediate networks, systems, or devices.

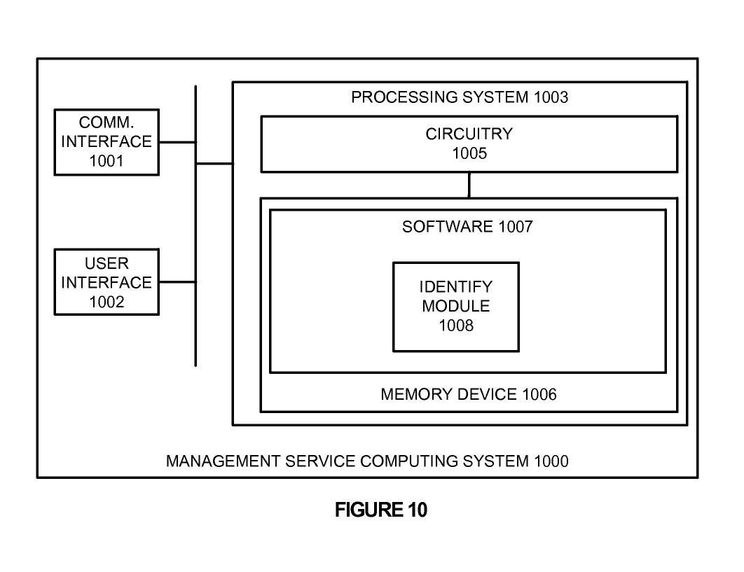

Turning to FIG. 10, FIG. 10 illustrates a management service computing system 1000 to provide security preferences to application containers. Computing system 1000 is an example of management service 160 and management system 960, although other examples may exist. Management service computing system 1000 comprises communication interface 1001, user interface 1002, and processing system 1003. Processing system 1003 is linked to communication interface 1001 and user interface 1002. Processing system 1003 includes processing circuitry 1005 and memory device 1006 that stores operating software 1007.

Communication interface 1001 comprises components that communicate over communication links, such as network cards, ports, RF transceivers, processing circuitry and software, or some other communication devices. Communication interface 1001 may be configured to communicate over metallic, wireless, or optical links. Communication interface 1001 may be configured to use TDM, IP, Ethernet, optical networking, wireless protocols, communication signaling, or some other communication format—including combinations thereof. In some examples, communication interface 1001 is configured to receive security preference requests from one or more application containers operating on at least one host computing system, and provide policy parameters to the containers once they are identified by the computing system.

User interface 1002 comprises components that interact with a user. User interface 1002 may include a keyboard, display screen, mouse, touch pad, or some other user input/output apparatus. In some instances, user interface 1002 may be configured to receive security preferences from an administrator that assists in configuring security parameters for the service applications. However, user interface 1002 may be omitted in some examples.

Processing circuitry 1005 comprises microprocessor and other circuitry that retrieves and executes operating software 1007 from memory device 1006. Memory device 1006 comprises a non-transitory storage medium, such as a disk drive, flash drive, data storage circuitry, or some other memory apparatus. Operating software 1007 comprises computer programs, firmware, or some other form of machine-readable processing instructions. Operating software 1007 includes identify module 1008. Operating software 1007 may further include an operating system capable of executing containerized applications, utilities, drivers, network interfaces, applications both containerized and stand alone, or some other type of software. When executed by circuitry 1005, operating software 1007 directs processing system 1003 to operate management service computing system 1000 as described herein.

In particular, communication interface 1001 communicates with at least one real or virtual computing device capable of hosting containerized applications. When a container is initialized on a host device, a security module within the container queries computing system 1000 to determine security preferences for the container and the application. Responsive to the query, identify module 1009 identifies the appropriate parameters or settings for the container based on the application within the container. For example, a front-end application for a service may require a different set of security parameters than a back-end application that is used to analyze the data after it is stored. To define the parameters, an administrator or any other relevant party may use user interface 1002, or an external device connected to management service computing system 1000, to input preferences regarding the particular applications.

Once the security parameters are identified for the container based on the input preferences, the parameters are then transferred for delivery back to the host and application container to be implemented. After implementation, the application may then execute for the service and provide the necessary data processes constrained by the security settings defined by management service computing system 1000.

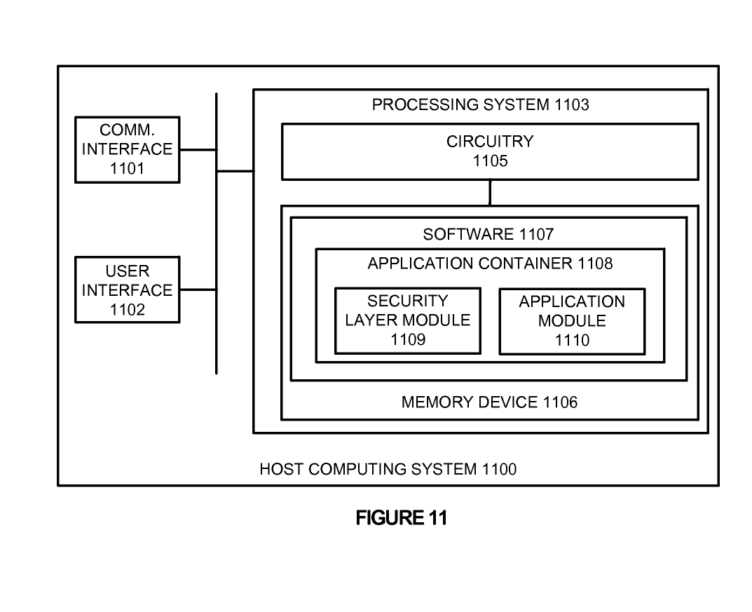

Referring now to FIG. 11, FIG. 11 illustrates a host computing system 1100 to provide secure application containers. Host computing system 1100 is representative of a computing system that may be employed in any computing apparatus, system, or device, or collections thereof, to suitably implement a host computing system described herein. Host computing system 1100 comprises communication interface 1101, user interface 1102, and processing system 1103. Processing system 1103 is linked to communication interface 1101 and user interface 1102. Processing system 1103 includes processing circuitry 1105 and memory device 1106 that stores operating software 1107.

Communication interface 1101 comprises components that communicate over communication links, such as network cards, ports, RF transceivers, processing circuitry and software, or some other communication devices. Communication interface 1101 may be configured to communicate over metallic, wireless, or optical links. Communication interface 1101 may be configured to use TDM, IP, Ethernet, optical networking, wireless protocols, communication signaling, or some other communication format—including combinations thereof. In some examples, communication interface 1101 is configured to communicate with an external management service computing system that can be used in identifying security parameters for containerized applications on the computing system.

User interface 1102 comprises components that interact with a user. User interface 1102 may include a keyboard, display screen, mouse, touch pad, or some other user input/output apparatus. User interface 1102 may be omitted in some examples.

Processing circuitry 1105 comprises microprocessor and other circuitry that retrieves and executes operating software 1107 from memory device 1106. Memory device 1106 comprises a non-transitory storage medium, such as a disk drive, flash drive, data storage circuitry, or some other memory apparatus. Operating software 1107 comprises computer programs, firmware, or some other form of machine-readable processing instructions. Operating software 1107 includes application container 1108, which further includes security layer module 1109 and application module 1110. Operating software 1107 may further include an operating system capable of executing containerized applications, utilities, drivers, network interfaces, applications both containerized and stand alone, or some other type of software. When executed by circuitry 1105, operating software 1107 directs processing system 1103 to operate host computing system 1100 as described herein.

In particular, host computing system 1100 may include one or more containerized applications that are capable of execution without dependencies on other applications or processes on host computing system 1100. When initialized, a process within security layer module 1109 may request security settings or parameters from a management service, which may be internal or external to host computing system 1100. Once the parameters are received from the management service, security layer module 1109 implements the settings to act as a security layer for application module 1110. For example, security layer module 1109 may be used to configure and act as a firewall to protect application module 1110 from interacting with improper applications and processes.

Although illustrated in the present example with a single application container, it should be understood that host computing system 1100 might include any number of application containers that are capable of execution without dependencies on other applications or processes on the host. Further, although FIGS. 10 and 11 include a particular number of processing modules, it should be understood that any number of processing modules might be included to provide the same functionality.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method of operating a management service to manage security preferences for containerized applications, the method comprising:
receiving an initiation request for a security layer in an application container;
responsive to the initiation request, identifying configuration parameters for the security layer in the application container, the configuration parameters corresponding to unique security preferences based on one or more applications in the application container; and
transferring the configuration parameters to the application container.

2. The method of claim 1 wherein the one or more applications comprise at least one front-end application.

3. The method of claim 1 wherein the one or more applications comprise at least one back-end application.

4. The method of claim 1 wherein the configuration parameters comprise at least encryption and firewall parameters.

5. The method of claim 1 wherein the unique security preferences comprise security preferences defined by an administrator for the one or more applications.

6. A computer apparatus to manage security preferences for containerized applications, the computer apparatus comprising:
processing instructions that direct a management service computing system, when executed by the management service computing system, to:
receive an initiation request for a security layer in an application container;
responsive to the initiation request, identify configuration parameters for the security layer in the application container, the configuration parameters corresponding to unique security preferences based on one or more applications in the application container; and
transfer the configuration parameters to the application container; and
one or more non-transitory computer readable media that store the processing instructions.

7. The computer apparatus of claim 6 wherein the one or more applications comprise at least one front-end application.

8. The computer apparatus of claim 6 wherein the one or more applications comprise at least one back-end application.

9. The computer apparatus of claim 6 wherein the unique security preferences comprise security preferences defined by an administrator for the one or more applications.

10. The computer apparatus of claim 6 wherein the application container is one of a plurality of application containers to provide a service.

11. A computer apparatus to provide security to an application with an application container, the computer apparatus comprising:
processing instructions that direct a host computing system, when executed by the host computing system, to:
identify a security configuration request initiated by a security layer within the application container;
responsive to the security configuration request, transfer a request to a management service for security configuration parameters corresponding to the application container; and
receive the security configuration parameters for the application container; and
one or more non-transitory computer readable media that store the processing instructions.

12. The computer apparatus of claim 11 wherein the configuration parameters comprise at least encryption and firewall parameters.

13. The computer apparatus of claim 11 wherein the processing instructions further direct the host computing system to:
in response to receiving the security configuration parameters for the application container, apply the security configuration parameters to the security layer within the application container.

14. The computer apparatus of claim 13 wherein the processing instructions to apply the security configuration parameters to the security layer within the application container direct the host computing system to apply at least firewall and encryption settings to the application container based on the security configuration parameters.

15. The computer apparatus of claim 11 wherein the security configuration parameters comprise parameters corresponding to unique security preferences based on the application in the application container.

16. The computer apparatus of claim 11 wherein the application comprises a front-end application.

17. The computer apparatus of claim 11 wherein the application comprises a back-end application.

18. The computer apparatus of claim 11 wherein the processing instructions further direct the host computing system to:
identify a second security configuration request initiated by a second security layer within a second application container;
responsive to the second security configuration request, transfer a second request to the management service for second security configuration parameters corresponding to the second application container; and
receive the second security configuration parameters for the second application container.

19. The computer apparatus of claim 18 wherein the second security configuration parameters are not equivalent to the security configuration parameters.

20. The computer apparatus of claim 11 wherein the application container comprises an isolated platform to execute the application without dependencies.
